(19) United States
(12) Patent Application Publication
(10) Pub. No.: US 2001/0031298 A1
(43) Pub. Date: Oct. 18, 2001

(54) Treatment of perishable products using aqueous chemical composition

(76) Inventor: Peter E. Fuller, Woods Cross, UT (US)

Correspondence Address: R. BURNS ISRAELSEN, WORKMAN, NYDEGGER & SEELEY, 1000 Eagle Gate Tower, 60 East South Temple, Salt Lake City, UT, 84111, US

(21) Appl. No.: 09/771,334

(22) Filed: Jan. 26, 2001

Related U.S. Application Data
(63) Continuation-in-part of application No. 09/414,300, filed on Oct. 6, 1999.
(60) Provisional application No. 60/222,764, filed on Aug. 3, 2000.
(60) Provisional application No. 60/178,623, filed on Jan. 28, 2000.
(60) Provisional application No. 60/103,705, filed on Oct. 9, 1998.

(51) Int. Cl. A23L 1/00

(52) U.S. Cl. 426/419; 426/418

(57) ABSTRACT

Aqueous compositions formed from combining water, and at least one solute such as sodium bicarbonate, acetylsalicylic acid or mixtures thereof, are used to introduce and maintain relatively high levels of carbon dioxide in the atmosphere of selected environments. The aqueous compositions benefit live plants and prolong the shelf life of various perishable foods and products, including vegetables, fruits, meats, fish, seafood, dairy products, and dry goods and ingredients. The aqueous compositions are applied directly by bathing or showering a perishable product in the aqueous compositions, or indirectly with absorption devices that carry the aqueous compositions, and which are placed in close proximity to a perishable product. An aqueous composition can be applied to or formed directly on an absorption device. An absorption device can also be recharged by reapplying or reforming the aqueous composition to the absorption device as needed.

### RELATED APPLICATIONS

This application is a continuation-in-part of U.S. patent application Ser. No. 09/414,300, entitled “Apparatus and Chemical Composition for Maintaining Atmospheric Humidity,” filed Oct. 6, 1999, which is a continuation-in-part of U.S. patent application Ser. No. 09/405,428, entitled “Evaporating Liquid into an Atmosphere,” filed Sep. 23, 1999, now issued as U.S. Pat. No. 6,106,775, which claims the benefit of U.S. Provisional Patent Application Serial No. 60/403,705, entitled “Apparatus and Methods for Evaporating Liquid into an Atmosphere,” filed Oct. 9, 1998. This application also claims the benefit of U.S. Provisional Patent Application Serial No. 60/222,764, entitled “Modification of Composition of Atmosphere to Preserve Perishable Products,” filed Aug. 3, 2000, and U.S. Provisional Patent Application Serial No. 60/178,623, entitled “Preservation of Perishable Products by Altering Composition of Atmosphere,” filed Jan. 28, 2000. The foregoing applications are incorporated herein by reference.

### BACKGROUND OF THE INVENTION

1. The Field of the Invention

The present invention relates to chemical compositions and associated apparatus and methods for altering the composition of an atmosphere. More specifically, the present invention relates to the use of aqueous compositions that are formed by mixing water, and at least one substance that dissolves in water, such as sodium bicarbonate, or a mixture of sodium bicarbonate and a weak acid such as acetylsalicylic acid, wherein the aqueous composition raises the level of carbon dioxide in an atmosphere and facilitates, enhances, or prolongs the preservation of perishable products.

2. The Prior State of the Art

Over the years, there has been an ongoing effort to prolong the usable life of perishable products. Among the products that are subject to decay, spoilage, or other degradation over time are meats, dairy products, fruits and vegetables, baked goods and other foods and plant materials such as cut flowers. Refrigeration is one of the principal techniques for preserving many types of perishable products. Nonetheless, refrigerated foods tend to become discolored, dry, wilted, or otherwise degrade. Some foods, such as many baked goods, are not usually refrigerated, since refrigeration tends to reduce their fresh look and flavor.

In view of the foregoing, there is a need in the art for new techniques for preserving perishable products. It would be particularly useful if such preservation techniques could be used with refrigeration or independently thereof. It would also be advantageous to provide preservation systems and methods that have low cost and are safe for use with foods intended for human consumption. Any increase in the shelf life of foods could have great benefit for many entities involved in the food industry, including retailers, shippers, restaurants, and consumers.

### SUMMARY AND OBJECTS OF THE INVENTION

The present invention relates to chemical compositions and associated apparatus and methods for generating and releasing carbon dioxide into an atmosphere. The chemical compositions are formed from combining water with at least one substance that dissolves in water such as sodium bicarbonate. Sodium bicarbonate, when exposed to the water, is a source of carbon dioxide that is released in gaseous form into the atmosphere and has a preservative effect on nearby perishable products that are exposed to the carbon dioxide. To enhance the production of carbon dioxide gas, the aqueous chemical composition further comprises a weak acid such as acetylsalicylic acid, which when mixed with sodium bicarbonate and water increases the generation of carbon dioxide gas. In addition to the generation of carbon dioxide, the apparatus and methods of the invention can increase the humidity of an atmosphere, particularly within enclosed environments, which can further preserve the perishable products stored therein.

The invention also relates to methods for using the aqueous compositions to prolong the useable life of a variety of perishable products, which may include foods, plant products, and the like. For instance, the aqueous compositions can be sprayed or otherwise applied to vegetables or other produce in grocery stores, restaurants, refrigerated trucks, or other locations, thereby maintaining the freshness of the produce for a period longer than is otherwise possible. Another method for applying the aqueous composition is to immerse a perishable product within the aqueous composition.

According to other implementations of the invention, the aqueous compositions can be applied by using absorbent materials and absorption devices that encase absorbent materials. Application of the aqueous chemical composition to an absorbent material can be performed in one of at least two general ways. According to the first, sodium bicarbonate and acetylsalicylic acid are applied directly to the absorbent material, such as during manufacture or assembly of the absorbent material. Later, water or another liquid comprising H₂O is applied to the treated absorbent material. This results in the formation of the aqueous chemical composition of the invention and causes a chemical reaction to generate carbon dioxide gas. According to the second method, the aqueous chemical composition of the invention is prepared by mixing sodium bicarbonate, acetylsalicylic acid and water prior to its application. The prepared aqueous composition is then applied to an absorbent material in a reactive state, already producing carbon dioxide gas. Once an absorbent material or absorption device is treated with the aqueous chemical composition of the invention, it can be placed in any desired space in which carbon dioxide is to be introduced for the enhancing or preservation of perishable products.

The methods and techniques used to preserve perishable products with the aqueous chemical composition of the invention have several advantages over other, significantly different techniques that might be used to increase the level of carbon dioxide in the atmosphere. For example, elevated levels of carbon dioxide can also be produced by discharging the gas from a tank containing carbon dioxide. However, as can readily be appreciated, the use of carbon dioxide tanks can be significantly more expensive, complicated, and even dangerous, compared to the application of the aqueous chemical composition of the present invention.

Applying the aqueous chemical composition of the invention to perishable products also has significant advantages over conventional humidifying devices. The absorption devices are self-contained units that do not require electrical power or other external energy sources. Accordingly, the absorption devices can be used in many environments where conventional humidifying devices have been impractical or impossible. The cost of manufacturing and operating the absorption devices disclosed herein are less than those associated with conventional humidifying systems, due to the simple design of the absorption devices, their lack of moving parts, and their ability to operate without electricity. Another advantages of using the absorption devices disclosed herein, include portability, reusability of the absorption devices in different locations, and ease of use.

It has been found that the aqueous chemical compositions of the invention can be used in many applications. For example, the devices of the present invention may be used to introduce carbon dioxide to produce bins, produce trucks, refrigerators, and directly to produce to extend the useable life or shelf life of produce beyond what has been previously possible. The invention can also be used to prevent exposed, refrigerated meats, fish, seafood, cheeses, and other similar foods from prematurely discoloring and spoiling. The shelf life of cookies, breads, cakes, brown sugar, tortillas, and other dry or non-refrigerated foods can also be extended according to the present invention.

Another benefit of the present invention is that it can be used to provide plants with an abundant supply of carbon dioxide gas, which is required by plants for photosynthesis.

Additional objects and advantages of the invention will be set forth in the description which follows, and in part will be obvious from the description, or may be learned by the practice of the invention. The objects and advantages of the invention may be realized and obtained by means of the instruments and combinations particularly pointed out in the description. These and other objects and features of the present invention will become more fully apparent from the following description, or may be learned by the practice of the invention as set forth hereinafter.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 is an illustration of the chemical compound sodium bicarbonate in an aqueous solution of water that shows carbon dioxide gas being formed.

FIG. 2 is an illustration of how acetylsalicylic acid and hydroxyl ions combine to form acetylsalicylate and water.

FIG. 3 is an illustration of the chemical compound acetylsalicylate being combined with sodium to form sodium acetylsalicylate.

FIG. 4 is an illustration of produce in a produce bin that is being sprayed with the aqueous chemical composition of the invention.

FIG. 5 is an illustration of an embodiment of an absorption pad of the invention that is being used in a produce bin.

FIG. 6 is an illustration of produce being bathed in the aqueous composition of the invention.

FIG. 7A is a breakaway perspective view illustrating an absorption device of the invention that includes a rigid shell casing.

FIG. 7B is a breakaway perspective view illustrating an absorption device similar to that of FIG. 7A, but with a different shape.

FIG. 8 is a flow chart illustrating the steps of a method according to the invention for assembling and later using an absorption device to deliver carbon dioxide to the atmosphere.

FIG. 9 is a breakaway perspective view illustrating an absorption device similar to that of FIG. 7A, but with a rectilinear shape and an impermeable top shell.

FIG. 10 is a side cross-sectional view of the absorption device of FIG. 9 that is sealed in a package containing meat.

FIG. 11 is a breakaway perspective view depicting a produce crate equipped with the absorption device of FIG. 9.

FIG. 12 is a breakaway perspective view depicting a produce crate equipped with the absorption device of FIG. 7A.

FIG. 13 is a perspective view illustrating an absorption device of the invention that includes a flexible mesh shell casing.

FIG. 14 is a perspective view illustrating a refrigerated display case containing meats and cheeses and being equipped with the absorption device of FIG. 9.

### DETAILED DESCRIPTION OF THE PREFERRED EMBODIMENTS

The present invention relates to chemical compositions and associated apparatus and methods for releasing carbon dioxide gas into an atmosphere. The chemical compositions are formed from combining water with at least one substance that dissolves in water such as sodium bicarbonate, or a mixture of sodium bicarbonate with a weak acid such as acetylsalicylic acid. The components of the chemical compositions are selected to generate carbon dioxide in an acid/base reaction. For example, it has been found that an aqueous composition formed from combining water, sodium bicarbonate, and acetylsalicylic acid is useful for raising and maintaining the level of carbon dioxide in air. A representation of the equilibrium reactions of the aqueous composition formed from combining sodium bicarbonate, acetylsalicylic acid and water are shown and described herein, in reference to FIGS. 1-3.

The aqueous compositions of the invention can be used to prolong the useable life or shelf life of a variety of perishable products, such as foods, plant products, and the like. For instance, vegetables and other produce can be showered or bathed in the aqueous chemical composition of the invention in grocery stores, restaurants, refrigerated trucks, or other locations, thereby maintaining the freshness of the vegetables or other produce for a period longer than is otherwise possible.

The invention also extends to the application of the aqueous compositions with absorption devices to conveniently introduce carbon dioxide into selected environments. The absorption devices used with the invention can include a shell encasing an absorbent material with holes formed through the shell to permit the flow of air between the exterior and interior of the shell. The permeable shell can either be a substantially rigid shell or a flexible shell, such as mesh netting. Once the aqueous compositions of the invention are applied to the absorbent material of an absorption device, the absorption device can be placed in any of a number of selected environments in order to increase the carbon dioxide level of those environments.

The absorption devices can be self-contained, portable and capable of being placed in and removed from various locations. Preferred embodiments of the absorption devices of the invention are passive, in that they do not require an electrical power supply or other external power sources. Instead, the absorption devices are placed in substantially any environment to which carbon dioxide is to be introduced and can operate without electrical energy.

The aqueous compositions of the invention have been found to have a variety of uses as applied in various applications. One use of the invention is for introducing carbon dioxide into selected environments according to the techniques that are disclosed herein. For example, the aqueous compositions can be used to extend the shelf life of vegetables and other produce in commercial and consumer settings. In addition, the invention can be used to preserve meats, fish, seafood, cheeses, other dairy products, and other foods in refrigerated environments. The aqueous chemical compositions have also been found to extend the shelf life and preserve the taste and other properties of dry food, such as breads, cookies, brown sugar, tortillas, and the like, in refrigerated and non-refrigerated environments. The aqueous chemical compositions of the invention are also useful for providing an ample supply of carbon dioxide for living plants. Furthermore, the appearance and taste of heated food, such as roasted poultry, hot dogs, and the like, can be maintained using the aqueous compositions of the invention over periods of time that are longer than those otherwise possible in the absence of the invention.

I. Aqueous Compositions

In one embodiment, the aqueous composition of the invention, which is formed from combining water, aspirin (acetylsalicylic acid), and sodium bicarbonate (baking soda), generates carbon dioxide and releases it in gaseous form into the atmosphere of a selected environment. This process is shown and described in reference to FIGS. 1-3. The subscript (aq) is used in FIGS. 1-3 to suggest the corresponding compounds are diluted in an aqueous solution such as water.

FIG. 1 shows that when NaHCO₃ (sodium bicarbonate) is diluted in water (H₂O), it dissociates into Na⁺_{(aq)} (sodium) and HCO₃⁻_{(aq)} (bicarbonate). Some of the HCO₃⁻_{(aq)} (bicarbonate) subsequently mixes with water (H₂O) of the aqueous solution and creates H₂CO_{3(aq)} (carbonic acid) and OH⁻_{(aq)} (hydroxyl anions). Carbonic acid is very unstable and further breaks down into CO₂ (carbon dioxide) gas and water (H₂O), as shown. It should be appreciated that FIG. 1 only represents an equilibrium reaction. Accordingly, the generation of carbon dioxide gas is limited because much of the available HCO₃⁻_{(aq)} (bicarbonate) does not react with the water, but rather remains in its present state.

According to the invention, a weak acid such as acetylsalicylic acid is added to the aqueous solution to enhance the reaction of HCO₃⁻_{(aq)} with H₂O, and to enhance the production of carbonic acid. Although acetylsalicylic acid is one example of a weak acid that can suitably react with sodium bicarbonate to enhance the release carbon dioxide when water is applied to the composition, there are other acids that can be used with the invention. By way of example, and not limitation citric acid and acetic are other examples of a suitable acid. In many applications, it is preferred that the acidic component and other components in the compositions be safe for use in proximity to foods that are intended for human consumption.

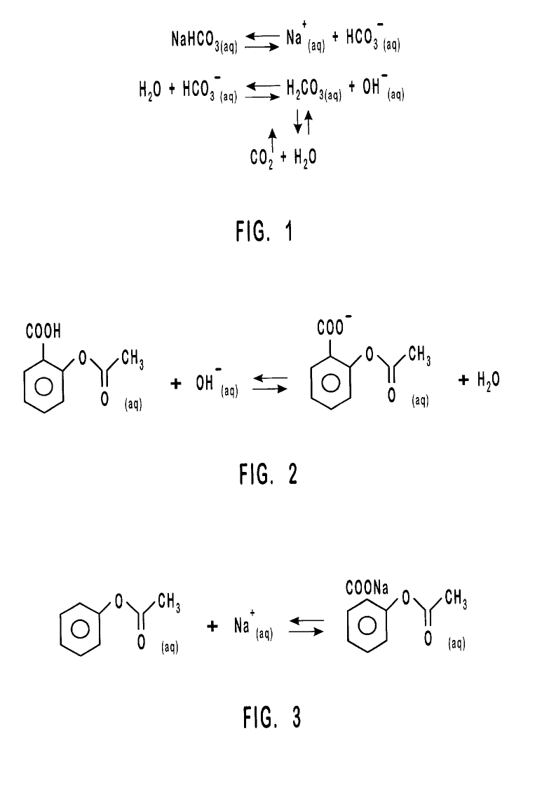

FIG. 2 shows that when acetylsalicylic acid is added to the aqueous solution, it combines with the hydroxyl anions (OH⁻_{(aq)}) to form acetylsalicylate and water. As shown in FIG. 3, acetylsalicylate subsequently bonds with the sodium (Na⁺_{(aq)}), which is left over from the reaction shown in FIG. 1, to form sodium acetylsalicylate.

One skilled in the art will appreciate that when the acetylsalicylic acid bonds with the hydroxyl anions (OH⁻_{(aq)}) that the equilibrium balance of the aqueous solution of FIG. 1 is disturbed. This causes more of the HCO₃⁻_{(aq)} (bicarbonate) to react with the water and results in the creation of more H₂CO_{3(aq)} (carbonic acid). It should also be appreciated that this enhances the production of carbon dioxide gas because the carbonic acid proceeds to break down into carbon dioxide and water.

It has been discovered that by using the present invention to increase the level of carbon dioxide gas in the atmosphere surrounding a perishable product, for instance, the useable life of that perishable product can be extended. One benefit of raising the level of carbon dioxide gas in a selected environment, such as around a perishable product is that it retards the growth of bacteria. Another benefit is that carbon dioxide displaces ethylene which is released by plant products. By displacing ethylene with carbon dioxide, it has been found that the useful life of cut plants and other perishable products can be extended. As will also be explained herein, it may also be desirable to raise the level of carbon dioxide gas in other environments, such as around live plants because plants use carbon dioxide gas for photosynthesis. The physical or chemical processes that may exist in any particular implementation of the invention are not critical to its utility. Indeed, it has been found that the invention is useful in a wide variety of environments for preserving perishable products. Accordingly, the invention extends to any such implementation, regardless of the physical processes that may be responsible for its preservative effects on perishable products.

While the amount and proportion of acetylsalicylic acid and sodium bicarbonate is certainly not critical to the generation of carbon dioxide, it has been found that the invention can be practiced by combining the acetylsalicylic acid and sodium bicarbonate at relative amounts by weight ranging from about 50% acetylsalicylic acid and 50% sodium bicarbonate to about 10% acetylsalicylic acid and 90% sodium bicarbonate. Combining the two substances at relative amounts by weight of about 20% acetylsalicylic acid and about 80% sodium bicarbonate is a preferred technique in some embodiments. However, other relative proportions of acetylsalicylic acid and sodium bicarbonate are entirely adequate and are encompassed by the invention. One method for creating the aqueous chemical composition of the present invention is to combine aspirin with baking soda and water. For example, in one embodiment, the aqueous chemical composition of the invention is produced by mixing six aspirin tablets (each about 325 mg), six tablespoons of baking soda, and five gallons of water.

II. Use of Aqueous Compositions

The aqueous compositions disclosed herein can be used to introduce and maintain high levels of carbon dioxide in the atmosphere of selected environments for various applications. In one embodiment, the aqueous composition is used in a space that contains food, and results in an elevated level of carbon dioxide gas in the environment of the food. To perform such methods, a technician places the aqueous composition of the invention in close proximity to the food that is to be preserved. As used herein, the term “close proximity” is defined to include placing the aqueous composition directly on the food and to also include placing the aqueous composition on or in an absorption device, with the absorption device being located in the space that contains the food.

Examples of food whose useable or shelf lives can be prolonged using the compositions of the invention include vegetables, fruits, meats, fish, seafood, cheeses, other dairy products, breads, cookies, brown sugar, tortillas, cooked poultry, cooked hot dogs, and other similar foods. The foregoing list of perishable products is presented by way of example and not by limitation. At times, the terms “meats,” “fish,” and “seafood” are used independently. However, it should be appreciated that the term “meat” is broadly construed to include any type of meat, seafood, fish or other animal product that can benefit from the preservative effects of the invention. Moreover, although it is noted that the foregoing foods include those that are generally refrigerated, the invention extends to foods that are stored at or near room temperature, and stored in a heated environment.

As used herein, the term “refrigerated” shall have its commonly understood meaning, and refers to low-temperature conditions in which produce, meats, dairy products, and the like, are conventionally stored in the food industry. A food that is stored without any particular refrigeration or heating requirements according to conventional practice in the food industry is one example of a food stored at or near room temperature. A “heated environment,” as used herein, extends to an environment heated to a temperature greater than room temperature for purposes of inhibiting spoilage or bacterial growth in foods. For instance, roasted chicken or cooked hot dogs are conventionally stored in heated environments for periods of time in the range of minutes or hours.

Any reference to the preservation of the usable or shelf life of food also extends to preservation of other products that are typically refrigerated or perishable, such as cut flowers. In addition, the aqueous compositions and the various methods for their use can be practiced in greenhouses or other controlled environments to enhance the growing conditions for live plants.

According to the invention, any reference to the preservation of perishable products should be construed to include the preservation of any food, live plant or other substance that benefits from the preservative effects of increasing the level of carbon dioxide in the environment or atmosphere surrounding the perishable product.

A. Direct Application

In one embodiment, the aqueous composition of the invention is applied directly to perishable food products. Methods for directly applying the aqueous composition to food include the acts of showering the food in the aqueous composition, bathing the food in the aqueous composition, and applying the aqueous composition to an absorbent material that is in direct contact with the food. As a mater of example and not limitation, the perishable food product may be located in a refrigerated unit in a truck or in a retailer's establishment, in a display case or produce bin at a grocery store, in a restaurant, or in any number of other locations.

Direct application of the aqueous composition has a dual effect of prolonging the useable life of perishable products such as vegetables, fruits, cut flowers, meats, fish, seafood, cheeses, and other similar foods from prematurely discoloring or spoiling. First, the aqueous composition generates carbon dioxide gas that is exposed to the perishable product and retards the degradation, discoloring and spoiling of the perishable product. Second, the aqueous composition is in direct contact with the food, thereby preserving the moisture content of the food.

In many grocery stores, produce is sprayed periodically with water to keep the produce hydrated and fresh. It is desirable, however, to reduce the frequency that produce must be sprayed because of the correlating probability that a customer will inadvertently get sprayed while examining the produce. According to the present invention, the frequency of which produce must be sprayed is reduced by using the aqueous chemical composition to enhance the hydration and preservative effects of each spray. The preservative effects of the aqueous chemical composition of the invention are described herein and relate to the production of carbon dioxide gas in the environment surrounding the perishable products. The hydration effects of the aqueous chemical composition are also described herein and are further described in U.S. patent application Ser. No. 09/414,300, entitled “Apparatus and Chemical Composition for Maintaining Atmospheric Humidity,” which was filed Oct. 6, 1999.

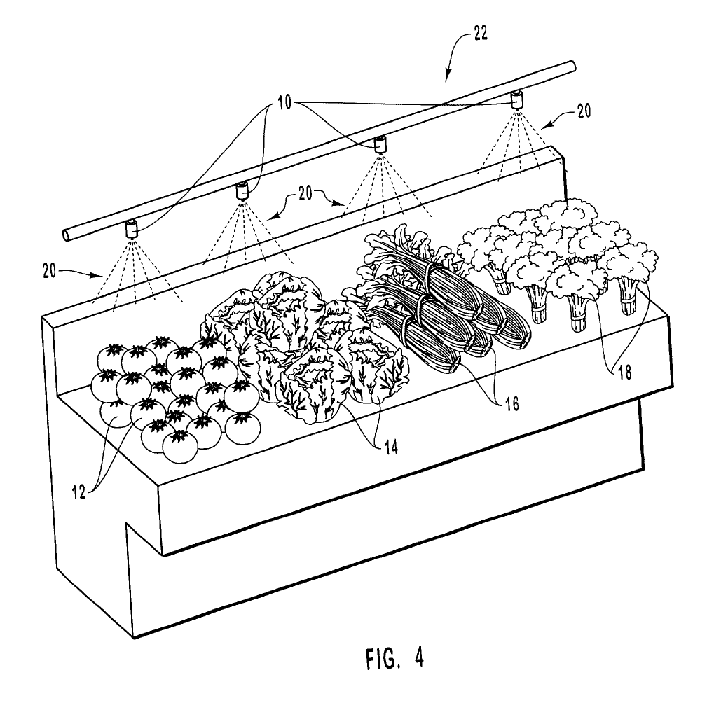

FIG. 4 illustrates one embodiment of the invention in which direct application of the aqueous composition is conducted by showering perishable products with the aqueous chemical composition of the invention. As shown, spray nozzles 10, which are conventionally used to spray water on vegetables or other produce, are used in this embodiment to shower the various produce products, including tomatoes 12, celery 14, lettuce 16 and broccoli 18 with the aqueous composition 20. Although the components of the aqueous composition 20 can be mixed at anytime, when direct application is preformed, it is useful to mix the components of the aqueous composition 20 shortly prior to the application, so as to prevent the carbon dioxide from being prematurely generated.

In one embodiment, the aqueous composition is prepared in a portable tank just prior to its application by a grocer. The grocer then connects the tank to an automatic spray system 22, such as the one shown in FIG. 4, or alternatively, the grocer carries the tank and manually sprays designated produce with a spray nozzle that is attached to the portable tank. The size of the portable tank may vary, depending on the method of application and the quantity of produce to be sprayed.

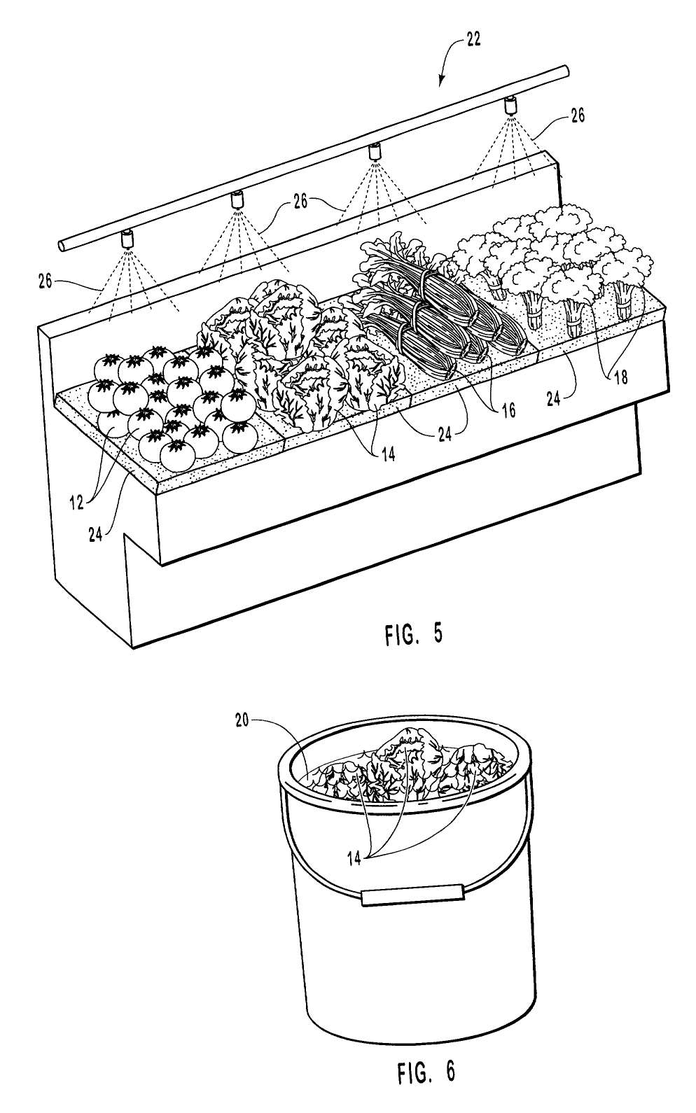

FIG. 5 illustrates another embodiment, in which an absorbent device comprising an absorbent pad 24 is placed in direct contact with perishable produce. The absorbent pad 24 of the present embodiment is treated with sodium bicarbonate and acetylsalicylic acid during manufacture or assembly of the pad, or at a later time. As shown in FIG. 5, absorbent pads 24 are placed in a produce bin under tomatoes 12, lettuce 14, celery 16, and broccoli 18. This embodiment is particularly useful when a grocer does not want to modify or configure an existing spray system 22 to spray the aqueous composition of the invention, as shown in FIG. 4. According to the implementation of this embodiment, excess water 26 is sprayed on produce from an existing spray system 22. The water drips off of the produce and is eventually absorbed by the absorbent pads 24. Once absorbed, the water 26 mixes with the chemical compounds that are located on or in the absorbent pads and forms the aqueous composition of the invention. In so doing, carbon dioxide gas is generated and the preservative effects of the carbon dioxide gas are applied to the produce.

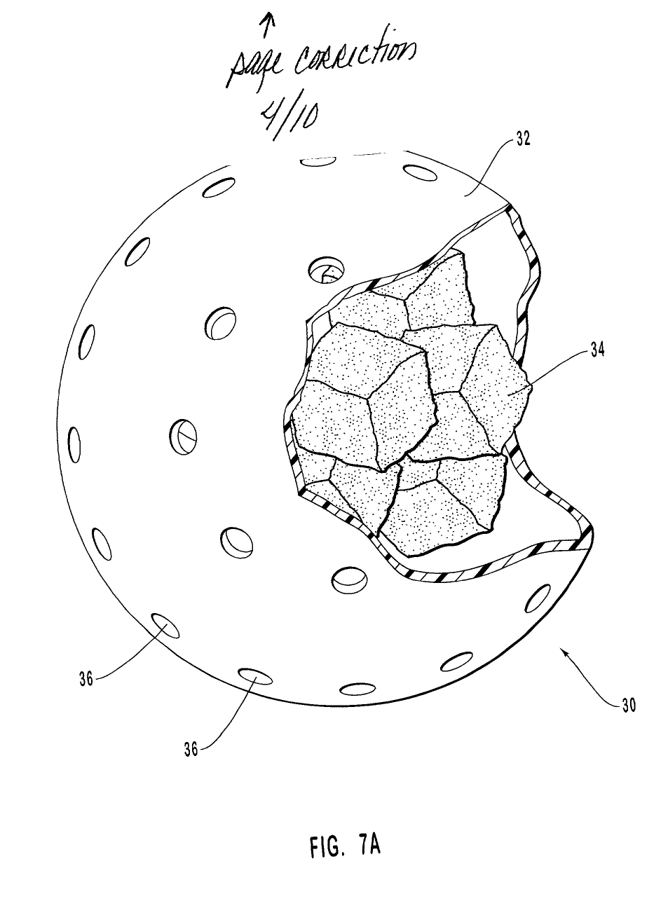

In another embodiment, shown in FIG. 6, the aqueous composition is applied directly to a perishable product by bathing or submersing the perishable product in the aqueous composition 20. As shown, heads of lettuce 14 are being submersed in a bath of the aqueous chemical composition 20 of the invention. It should be appreciated that by bathing a perishable product, such as lettuce 14 in the aqueous composition 20, it is possible to expose portions of the perishable product to the aqueous composition 20 that are otherwise sheltered during the spraying process described above. The bathing technique is also beneficial for ensuring a greater quantity of the aqueous composition is applied to the perishable product, which in turn ensures a greater quantity of carbon dioxide gas will be generated, and which further enhances the preservative effects of the invention. Bathing or showering a perishable product can occur at anytime. It may be desirable, for instance, to treat a product prior to packaging, shipping, storing and/or displaying the product for sale.

Although FIGS. 4-6 illustrate the use of the aqueous composition of the invention being used to extend the useful life of produce products, it should be appreciated that each of the techniques and methods described herein can also be used to extend the useful life of meats, fish, seafood, cheeses, cut flowers and other perishable products. With particular reference to cut flowers, it has also been found that using the present invention with cut flowers not only extends the useful life of the cut flowers, but it also enhances the color and appearance of the cut flowers.

B. Absorption Device

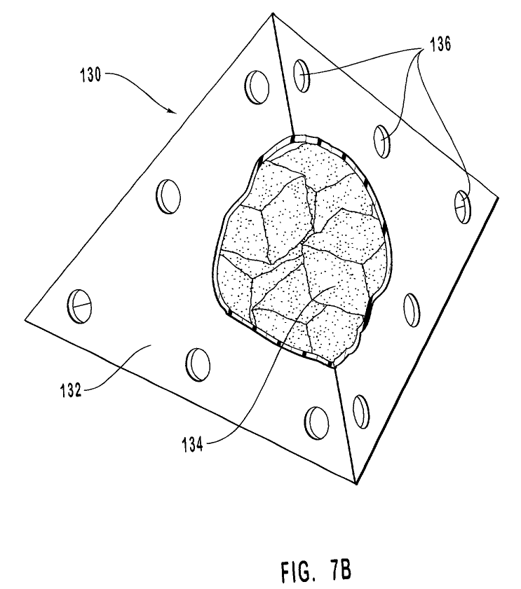

In another embodiment, the aqueous composition is applied to or formed in or on an absorption device, such as that illustrated in FIG. 7A. Absorption device 30 includes a substantially rigid outer shell 32 (shown in breakaway view) encasing an absorbent material 34. Shell 32 has one or more holes 36 formed therethrough, which permits the transport of gas between the interior and the exterior of the shell. Preferably, shell 32 has a plurality of holes 36 randomly or regularly spaced thereon. The size of holes 36 can be selected to substantially prevent portions of absorbent material 34 from protruding outside of shell 32 during use and to substantially prevent objects in the environment of absorption device 30 from coming in contact with the absorbent material 34. The size and number of holes 36 on shell 32 can be selected to increase or decrease the airflow rate between the interior and exterior of shell 32 and to control the rate of dispersion of carbon dioxide from the absorption device.

Absorbent material 34 can be essentially any material capable of retaining an aqueous medium in a manner such carbon dioxide generated in the aqueous medium is released into the atmosphere. Suitable examples of absorbent material 34 include natural sponges and synthetic sponges, such as those commonly used in household settings. When absorbent material 34 consists of natural or synthetic sponges, the absorbent material can be divided into cubes or other regular or irregular shapes, one example of which is illustrated in FIG. 7A. Dividing absorbent material 34 into multiple pieces as illustrated provides the advantage of permitting air to flow around and between the pieces, and also increases the exposed surface area of the absorbent material from which moisture can evaporate and from which carbon dioxide can be dispersed.

In a preferred embodiment, absorbent material 34 is not packed in shell 32 so tightly that the interstices between the individual pieces and between the absorbent material and shell 32 are eliminated. Preserving some air space inside shell 32 permits adequate airflow through device 30, thereby enhancing the operation of the absorption device.

Shell 32, depending on the environment in which absorption device 30 is to be used, can be constructed of any of a large number of materials. In one embodiment, shell 32 is constructed of a substantially rigid thermoplastic or thermosetting plastic. The factors involved in selecting the material for shell 32 can include water resistance, durability, wear properties, and inertness with respect to the materials expected to be encountered in the environment of absorption device 30. Other examples of materials for use in shell 32 include metals and, in some applications, wood.

The aqueous composition is applied to absorption device 30 according to one of at least two techniques. First, the substances that will eventually dissolve in water, such as sodium bicarbonate and acetylsalicylic acid, can be deposited at or in the absorbent material 34 during or after the manufacturing process, and before the introduction of water into absorption device 30. According to this technique, the act of forming the aqueous composition is conducted as water is applied to absorbent material 34 and mixes with one or more solutes such as sodium bicarbonate and acetylsalicylic acid. For example, device 30 can be immersed in a volume of water or water can be poured over device 30. In either case, water enters holes 36 and is absorbed by absorbent material 34. Some or all of the water can eventually evaporate from absorbent material 34, which reduces the amount of carbon dioxide that is generated. However, device 30 can be easily recharged in this situation by reapplying the composition to the absorbent material. It has been found that residual sodium bicarbonate and acetylsalicylic acid can remain at absorbent material 34 during repeated recharging and evaporation cycles. Thus, the act of recharging device 30 can often merely include reapplying water to the absorbent material 34, which contains the residual sodium bicarbonate and acetylsalicylic acid. The production of carbon dioxide resumes whenever the absorbent device 30 is recharged.

One benefit of generating carbon dioxide using the absorbent devices disclosed herein is that they can be selectively activated by the application of water. Prior to activation, the absorption devices introduce essentially no carbon dioxide into the atmosphere.

According to a second technique for applying the aqueous composition to absorption device 30, the composition is formed outside of the absorption device by combining water with the sodium bicarbonate and acetylsalicylic acid. For instance, a volume of the composition can be generated by the same technician who applies the composition to the absorption device or, alternately, the composition can be manufactured and distributed to the end user. In this case, the act of applying the aqueous composition to absorption device 30 can include immersing the device in the aqueous composition or pouring it over the absorption device.

Once absorption device 30 has the aqueous composition applied thereto, it is ready to be used to supply carbon dioxide to the environment. Absorption device 30 introduces carbon dioxide into an environment as the sodium bicarbonate and the weak acid react in an acid/base reaction. Holes 36 permit carbon dioxide to flow out of shell 32, and also allow water vapor to diffuse into the external environment. As can be seen in FIG. 7A, absorption device 30 can be an entirely passive device in the sense that no electrical or other power supply is required. Moreover, in many instances, absorption device 30 can supply a suitable amount of carbon dioxide without the use of fans or other devices for generating airflow over the absorption device. Of course, in some situations, inducing airflow over and through absorption device 30 using any desired external system can enhance the evaporation and introduction of moisture into the environment, and may be employed when such results are desired.

One significant advantage of the absorption devices of the invention is their low costs compared to applying carbon dioxide from tanks or the like.

Absorption device 30 can have substantially any desired size or shape. While absorption device 30 of FIG. 7A is spherical, other shapes can be used. Indeed, in many situations, shapes other than a sphere may be desired. For instance, a cubical, pyramidal, or other prismatic shape can reduce the possibility of the absorption device rolling out of position. In any case, the invention extends to absorption devices constructed according to the principles disclosed herein, regardless of the shape.

FIG. 7B illustrates an example of an absorption device 130 having a shape different from that of absorption device 30 of FIG. 7A. In all other respects, absorption device 130 can be similar or identical to absorption device 30. For instance, absorption device 130 has a shell 132 that substantially encloses an absorbent material 134. Shell 132 has one or more holes 136 formed therethrough that permit flow or air between the interior and exterior of the shell.

In many circumstances, it can be desirable to provide absorption devices having a sufficiently small size to allow them to be lifted by a user and to be easily immersed in a volume of water. However, it should be recognized that absorption devices can be as large as desired. Because of the self-contained and portable nature of absorption devices they can be relatively easily sterilized between uses if desired. For example, absorption devices can be immersed in boiling water or can be exposed to other thermal or chemical sterilization means.

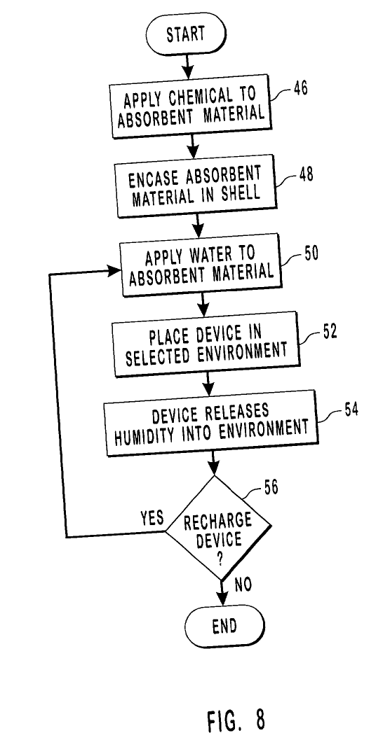

FIG. 8 is a flow diagram illustrating one embodiment of the methods for using the aqueous composition and the absorption device of the invention to introduce and maintain relatively high levels of carbon dioxide in the atmosphere of a selected environment. As shown in step 46, one or more substances, such as acetylsalicylic acid and sodium bicarbonate, are applied to the absorbent material of the absorption device. In step 48, the absorbent material is encased in the shell. At this stage in the method, the absorption device has been manufactured and is ready for use.

In step 50, water is applied to the absorbent material by immersing the absorption device in a volume of water or by pouring water over the absorption device. Some of the water is absorbed into and retained by the absorbent material. The absorption device is then placed in the selected environment into which carbon dioxide is to be introduced in step 52. As shown by step 54, the absorption device releases carbon dioxide into the environment as disclosed herein. Depending on the nature of the environment, the absorbent material may eventually dry out, at which point the absorption device can be recharged. According to decision block 56, if the absorption device is to be recharged, the method advances again to step 50.

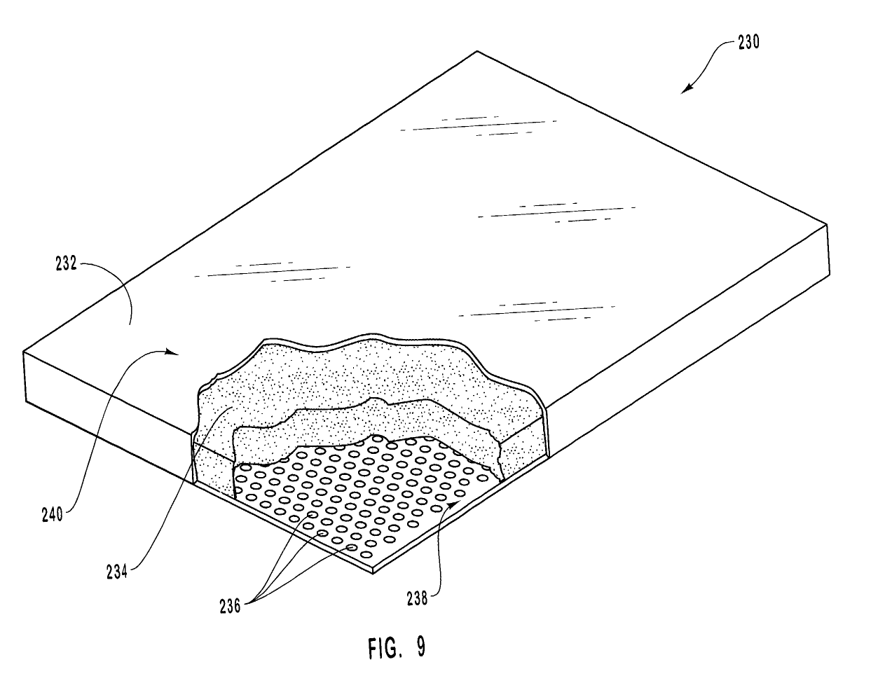

FIG. 9 illustrates another embodiment of the absorption device of the present invention. As shown, absorption device 230 is embodied in the shape of a rectilinear pad having multiple layers. In all other respects, absorption device 230 is similar to or identical to absorption device 30 and 130 of FIGS. 5A and 5B, respectively. In particular, absorption device 230 comprises a shell 232 that substantially encloses an absorbent material 234.

According to one implementation of the present embodiment, the absorbent material 234 is treated with sodium bicarbonate and acetylsalicylic acid before it is encased within the shell 232. The bottom layer 238 of the shell 232 comprises a permeable hydrophobic material that has one or more small holes 236 formed therethrough that permit the flow of gas and liquid between the interior and exterior of the shell 232. The top layer 240 of the shell 232 is comprised of an impermeable hydrophobic material that prevents liquid within the absorbent material from being absorbed by a perishable product resting on top of the absorption device. One skilled in the art will recognize that the impermeability of the top layer 240 serves a sanitary function of preventing the spread of bacteria. It should also be appreciated, however, that it some instances where there is a minimal amount of harmful bacteria that can be spread that it may be desirable for the top layer 240 of the shell to be comprised of a permeable material, in which case it can be.

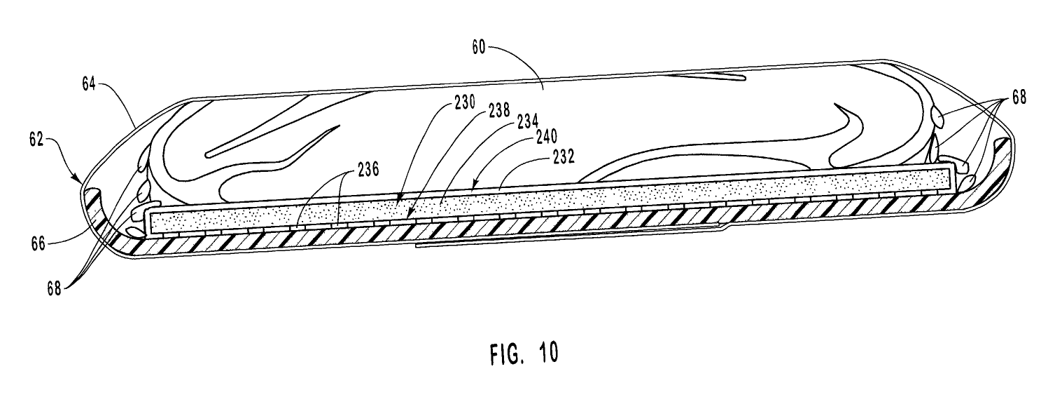

As shown in FIG. 10, the absorption device 230 of the present embodiment is packaged with meat 60 or another perishable product in a conventional package 62, such as the one shown that includes cellophane wrap 64 and a rigid foam tray 66. The purpose of sealing the meat 60 within the package 62 is to retard the discoloration, degradation and spoilage of the meat 60. As will be described, absorption device 230 is used to extend the useful life of the meat 60 or another perishable product that is sealed within package 62.

After meat 60 is packaged it produces juices and other exudates 68 that drip down to the bottom of the packaging 62. Exudates 68 are captured by the tray 66 and are subsequently absorbed by the absorbent material 234 through the holes 236 in bottom layer 238 of the shell. The exudates 68 contain water (H₂O), which mixes with the sodium bicarbonate and acetylsalicylic acid contained on or in the absorbent material and forms the aqueous composition of the present invention. This process is shown and described in reference to FIGS. 1-3, in which the aqueous composition causes a chemical reaction to occur, and which generates carbon dioxide gas. The carbon dioxide gas is then dispersed through the shell 232 into the packaged environment surrounding the meat 60. It has been found that by using an absorption device 230 in this manner, the enclosed environment surrounding the meat 60 maintains a relatively high level of carbon dioxide gas, which in turn retards the discoloration and degradation of the meat 60.

The hydration and preservative effects of the absorption device of the present embodiment can also be used to extend the useful life of packaged vegetables, such as mushrooms and lettuce that are washed just prior to packaging. One such implementation is shown in FIG. 11. As shown, heads of lettuce 14 that have recently been washed are packaged in a crate 70 and are sitting on an absorbent pad 230 of the invention that contains sodium bicarbonate and acetylsalicylic acid. Over time, water (not shown) drips off of the heads of lettuce 14 and is eventually absorbed into the absorbent pad 230 where it mixes with the chemical compounds on or in the absorbent pad 230. The aqueous composition of the invention is formed when the water finally mixes with the sodium bicarbonate and acetylsalicylic acid. Once the aqueous composition is formed, carbon dioxide gas is produced and surrounds the heads of lettuce 14 within the crate 70 and extends the useful life of the lettuce 14. Uses of the absorption device of the present embodiment also extend to use in grocer bins where produce is sprayed with water, as described in reference to FIG. 5.

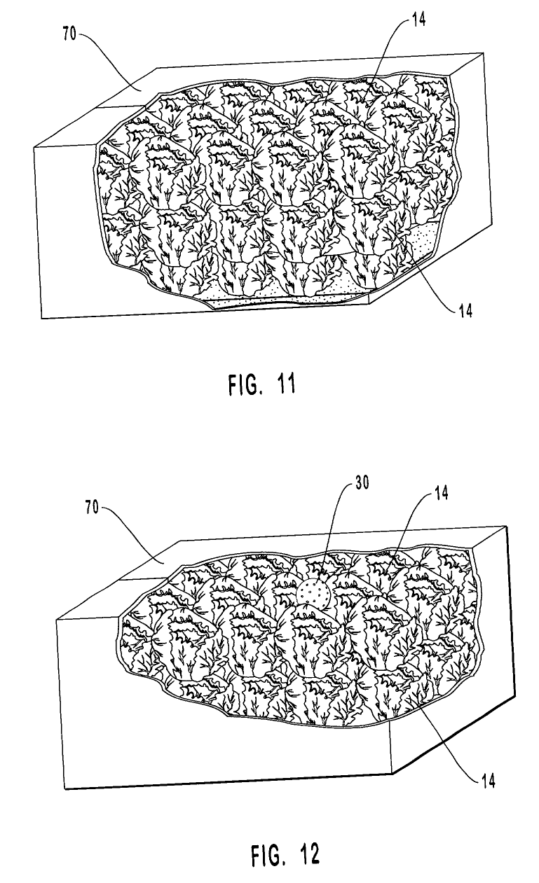

FIG. 12 illustrates another embodiment in which the absorption device of the invention is used to preserve the shelf life of produce. According to this embodiment, absorption device 230 is constructed and activated by the application of water as described above in reference to FIG. 9. FIG. 12 illustrates a produce crate 70 containing heads of lettuce 14 that have been packed after being harvested and are prepared to be shipped to retailers, where the lettuce will be sold to consumers. It is widely understood in the produce industry that lettuce, other vegetables, and other produce have a limited shelf life, and must be sold to consumers within a specified amount of time. The limited shelf life contributes to significant shipping and handling expenses, since the produce must be delivered to the consumer is a short amount of time.

It is standard practice in the produce industry to sell lettuce to consumers within four or five days after the lettuce has been harvested from the field. Accordingly, lettuce ordinarily is shipped to the retailer within about 72 hours after harvest. This rough 72-hour standard limits the distance that lettuce can be shipped by truck from particular growing areas. Moreover, for geographic regions relatively distant from lettuce growing areas, lettuce must be in transport nearly night and day in order to arrive within the 72 hours. Such intense shipping practices combined with occasional spoilage contributes to the expense of produce at the consumer level.

It has been found that including an absorption device 30 in crate 70 before the heads of lettuce 14 or other produce is shipped can inhibit the spoilage or other degradation of the produce. When absorption device 30 is placed in the environment of lettuce 14 or other produce, particularly in closed spaces as shown in FIGS. 11 and 12, the carbon dioxide introduced into the environment has a preservative effect on the produce. For instance, it has been discovered that using the aqueous compositions and absorption devices of the invention can lengthen the traditional shelf life of produce by an additional one to three days or more.

It has also been found that placing absorption device 30 in a refrigerated truck that transports the lettuce has a similar preservative effect on the produce. Moreover, experimentation has shown that absorption device 30 can also extend the shelf life of produce that is stored in a refrigerated unit at a grocery store or displayed in a refrigerated display case.

Delivering carbon dioxide to refrigerated produce environments as shown in FIGS. 11 and 12 has significant advantages over merely placing electrically operated humidifying systems in refrigerated trucks or other refrigerators. For example, absorption device 30 can be conveniently placed within individual crates as shown in FIG. 12, which has not been possible using electrical systems. Moreover, the absorption devices of the invention are significantly less expensive to manufacture and operate the electrically powered humidifying systems. In addition, absorption device 30 can remain in crate 70 after the crate 70 is transported from the truck space to the retailer's cold storage unit. Beyond such logistical advantages, it has been found that the use of the absorption devices with the aqueous composition of the invention to increase the level of carbon dioxide in a produce environment can extend the usable life of lettuce and other produce well beyond what has been achieved by conventional electrically powered humidifying systems.

While FIGS. 11 and 12 illustrate absorption devices of the invention being used with lettuce 14, the invention can be practiced with substantially any other type of vegetable, with many fruits, and with meats to extend the usable life thereof. The preservative effects of the invention can be observed in a variety of situations, including those wherein the absorption devices carrying the aqueous composition are placed in a refrigerated truck, a walk-in refrigeration unit at a grocery store, or in other refrigerated environments.

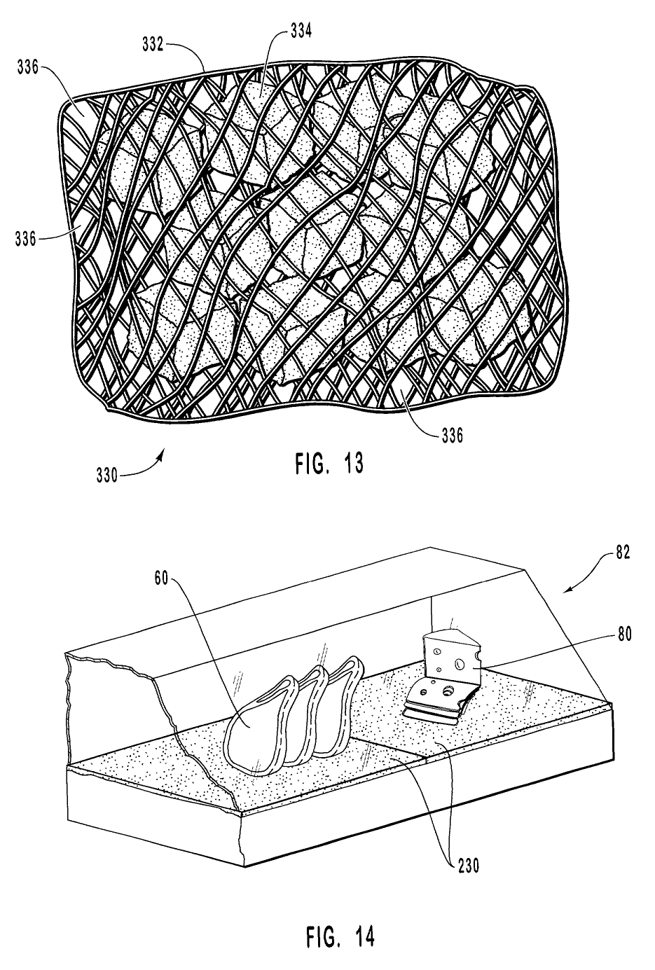

The absorption device of the invention is also useful for hydrating and preserving the contents of sealed bags of perishable products, such as mixed salad. When used in this manner, it is preferable that the shell of the absorption device be flexible and lightweight so that it will be less likely to damage the lettuce and other contents of the mixed salad. FIG. 13 shows one suitable embodiment of the absorption device 330 for use with mixed salads. It should be appreciated that absorption device 330 is substantially similar to absorption devices 30, 130, and 230 of FIGS. 7A, 7B, and 9, respectively. In particular, absorption device 332 comprises a shell 332 with holes 336 and an absorbent material 334 encased within the shell 332. According to the present embodiment, shell 332 comprises a mesh bag or casing that is formed from nylon or another natural or synthetic fiber or fabric. It should be understood that the shell 332 can have substantially any form and can be constructed of substantially any material so long as the shell 332 is capable of encasing the absorbent material 334 and includes one or more holes 336 for air to pass through. The present embodiment is very practical because the shell 332 is flexible and lightweight which makes amenable for shipping and storage.

When the absorption device 330 is used in sealed bags of mixed salad or cut lettuce, it is beneficial to attach the absorption device 330 to the interior of the sealed bag so as to reduce the risk that a consumer may inadvertently eat the absorption device 330.

FIG. 14 illustrates another use of the absorption devices of the invention, whereby meats, fish, seafood, cheeses, and other refrigerated foods are preserved. Restaurant operators and grocery retailers often display meats 60, cheeses 82, and other similar foods in refrigerated display units 82. In order to display these foods to consumers, they are often left uncovered. However, the exposure of meats 60 and cheeses 82 to the ambient air induces a degradation process that discolors the food and can also have a deleterious effect on the foods' taste.

When absorption device 230 of FIG. 9 is used in refrigerated unit 82, the aqueous composition of the invention is formed, carbon dioxide is produced, and the benefits of the invention are realized when water is applied to the absorption device, or alternatively, when exudates of the perishable products are absorbed by the absorbent material in the manner described in reference to FIG. 10.

It has been found that using one or more absorption devices 230 in refrigerated display unit 82 increases the level of carbon dioxide within the display unit 82 and has the effect of inhibiting the discoloration of meats 60 and cheeses 80 and otherwise preserves the shelf life thereof. The portable, reusable, and non-energy consumptive properties of absorption devices 230 provide many of the same advantages in the context of FIG. 14 as those described in the other examples disclosed herein. Among the many advantages of using absorption devices 230 in refrigerated display units 82, the food contained therein can be left uncovered for an extended period of time. For example, retailers and restaurant operators have the option of leaving meats 60 and cheeses 80 uncovered overnight, while preserving the appearance of the food and otherwise extending its shelf life. This embodiment of the methods of the invention can also be practiced in other refrigerated units at the retail level and in refrigerators of consumers.

It should be appreciated that the absorption devices of the present embodiment can be used in any of the embodiments described herein to raise the level of carbon dioxide in a refrigerated unit where meats, seafood, cheeses, flowers and other perishable products are displayed for sale. The benefits of the invention can also be realized in room temperature environments and in heated environments.

C. Application to Plants

An absorption device having a shell and enclosed absorbent material that contains the aqueous composition of the invention can also be used to introduce carbon dioxide to various plant environments. Such plant environments can include greenhouses, terrariums, and the like. Placing the absorption device in plant environments can reduce the frequency by which plants must be watered, and can maintain a desirably high level of carbon dioxide, which facilitates the growth of plants. In another embodiment, an absorption device can be configured to receive or be placed near to one or more seeds to facilitate the germination thereof. In this case, the absorption device may be given a shape and size that conveniently allows the seeds to be secured in or near the absorption device.

It has been found that the generation and release of carbon dioxide can be performed by applying the aqueous compositions of the invention, or the components from which they are formed, to soil in which plants are germinated or grown. For example, sponges or other absorbent material that have sodium bicarbonate and an acid, or an aqueous composition formed from these substances, can be placed in soil in which plants are grown. Alternatively, the sodium bicarbonate and the acid can be directly applied to or mixed with the soil. Such application of the reactive species can be performed prior to selling a bag of treated soil or can be performed by a consumer (e.g., a hobbyist or agriculturalist). Consumers can be enabled to treat the soil according to the latter technique by providing packages of pre-mixed preparations of sodium bicarbonate and acid can to the consumers.

The soil can be potting soil used to support houseplants or plant in nurseries or greenhouses or can be natural soil used in agricultural operations. When water is applied to the treated soil, the reaction of the sodium bicarbonate and the acid is activated, with carbon dioxide being released both into the soil and into the adjacent atmosphere. The carbon dioxide is thereby available to facilitate the germination and/or growth of the plants in the soil.

According to another embodiment, a sponge or another absorbent material containing the aqueous compound of the invention can be positioned on a shaft so that the absorbent material can be placed in proximity to cut flowers or live plants, thereby delivering carbon dioxide into the atmosphere surrounding the cut flowers or plants. Examples of such structures that can be adapted for use with the invention are disclosed in U.S. patent application Ser. No. 09/454,203, filed Dec. 3, 1999, entitled “Humidification of Environment Surrounding Cut Flowers and Other Plant Materials,” which is incorporated herein by reference.

Absorption devices carrying the aqueous compositions of the invention can also provide significant benefits when placed in greenhouses where plants are grown. For example, the absorption devices can significantly increase the levels of carbon dioxide in enclosed growing environments, which otherwise naturally decrease as photosynthesis occurs. Substantially any plant grown in greenhouses or controlled environments, including vegetables, flowers, rice, etc., can benefit from the maintenance of adequate carbon dioxide associated with the use of the absorption devices and aqueous compositions of the invention.

D. Other Application Devices and Environments

A variety of other absorbent devices can be used in combination with the aqueous compositions of the invention to generate and release carbon dioxide into the atmosphere of various environments. The invention can also be adapted for use with other absorbent devices and techniques for applying aqueous compositions of the invention. Examples of such absorbent devices and techniques are disclosed in U.S. patent application Ser. No. 09/405,428, filed Sep. 23, 1999, entitled “Evaporating Liquid into an Atmosphere” and U.S. patent application Ser. No. 09/414,300, filed Oct. 6, 1999, entitled “Apparatus and Chemical Composition for Maintaining Atmospheric Humidity,” which are incorporated herein by reference.

### III. EXAMPLES

A number of examples of the use of the aqueous compositions of the invention follow in order to illustrate the wide range of applications of the aqueous compositions and the benefits that have been derived from their use. The following examples illustrate uses of absorption device in combination with the aqueous compositions of the invention, unless indicated otherwise

### Example 1

In one experiment, it was found that the absorption devices disclosed herein extend the usable life of lettuce one to three days beyond that which is otherwise observed. In particular, the onset of yellowing of lettuce leaves and other degradation of the lettuce was delayed about one to three days when an absorption device carrying the aqueous composition was placed in a refrigerated unit where the lettuce was stored. Such food preservation capabilities can have great advantages in the produce industry. Shipping expenses can be reduced because the urgency of delivering the produce to the retailer is diminished. In addition, the retailer can now receive produce shipments on a weekly basis instead of receiving shipments every day or several times a week as has previously been common.

### Example 2

In another experiment, the aqueous composition was applied to an absorption device that was placed directly in a fresh vegetable salad that included a quantity of cut lettuce and other vegetables. It was found that the vegetable salad remained fresh, green, and had an attractive appearance for a longer period of time than has been observed in the absence of the absorption device. Thus, restaurant operators can advantageously use the present invention to prolong the useable life of vegetable salads and obtain costs savings both in the frequency of preparing such salads and in the amount of food that spoils and must be discarded.

### Example 3

It has been found that when absorption devices carrying the aqueous compositions are used in an open-air refrigerated produce display case at a grocery store that the shelf life of a variety of vegetables and fruits is extended. In one experiment, a number of absorption devices carrying an aqueous composition of the invention were placed near the rear of an open-air refrigerated produce display case at regular intervals of about two feet. The absorption devices had a dimension of about 2 inches×2 inches×2 inches.

In this experiment, the leafy vegetables maintained a fresh and attractive appearance longer than was observed in the absence of the invention. Moreover, the useable life of the vegetables and fruits was prolonged by an amount similar to that described above in Examples 1-2.

### Example 4

It has been found that placing absorption devices in retailers' refrigerated cut flower cases has a preservative effect on the flowers. Leaves and petals maintain an attractive and fresh appearance for a period of time longer than that observed in the absence of the invention. Particularly delicate flowers, such as baby's breath, have experienced some of the most significant benefits.

### Example 5

Grocery stores and retailers often display shaved meats, cheese, potato salads, egg salads, macaroni salads, and the like, in deli display cases. In the absence of the invention, many retailers find it desirable to stir or turn salads roughly every hour due to the drying and discoloration of the surface of the salads as they are exposed to air. It has been found, however, that by using the absorption devices carrying the aqueous compositions of the invention, salads only need to be turned once every several hours in order to maintain a fresh and attractive appearance.

### Example 6

In one experiment, absorption devices carrying the aqueous composition of the invention and having a dimension of approximately 2 inches×2 inches×2 inches were placed in a service meat display case similar to the display unit 82 of FIG. 14 in order to observe the preservative effects on meat and seafood. The absorption devices were positioned roughly every two feet along the length of the case. In order to enhance the mixing of the carbon dioxide into the atmosphere, the devices were positioned near an airflow unit that circulates refrigerated air through the case.

As a result of using the absorption devices, the exposed meats maintained a fresh appearance for a period of time longer than that observed in the absence of the invention. This effect can lead to less frequent loss of meat due to discoloration and other spoilage. In addition, vegetable garnishes, such as kale, that were displayed along with the meats experienced significantly diminished drying and discoloration. For instance, the operator of the service meat display case found it entirely acceptable to replace the garnishes on the order of once every five days rather than on a daily basis, which had been necessary prior to the experiment.

### Example 7

In another experiment, absorption devices carrying an aqueous composition of the invention were positioned in a heated display case used to store cooked food, including fried chicken, mashed potatoes, and macaroni. Prior to the use of the absorption devices of the invention, fried chicken was typically discarded at roughly 1 to 1½ hours after cooking due to loss of moisture. In the experiment, the absorption devices were positioned in the heated display case, with some being located directly in a pile of fried chicken, and others being in locations other than in direct contact with the food products.

As a result of the experiment, it was found that the mashed potatoes and macaroni maintained an acceptably good appearance and freshness for an extended period of time. Furthermore, the fried chicken retained its moisture and appearance to the extent that it remained useable after two to three hours or more.

### Example 8

In yet another experiment, beef steaks weighing 594.7 g were stored in a sealed bucket for a period of seven days at a temperature of 1° C. At the end of the seventh day, the steaks had decreased in weight by 4.4 g. In contrast, when the absorption device of the present invention was placed in a second bucket with substantially similar steaks over the same seven-day period at the same temperature, the steaks, originally weighing 497.5 g, gained 12.4 g. This experiment also showed that at the end of the seven days, the bacterial plate count on the surface of the steaks, although originally the same for both groups of steak, was less for the steaks held in the presence of the absorption device. Accordingly, it should be appreciated that one benefit of the present invention is that can retard the degradation of meat products.

The present invention may be embodied in other specific forms without departing from its spirit or essential characteristics. The described embodiments are to be considered in all respects only as illustrative and not restrictive.

What is claimed and desired to be secured by United States Letters Patent is:

1. A method for raising the level of carbon dioxide in an environment surrounding a perishable product so as to prolong the useable life of the perishable product, comprising the acts of:
obtaining an aqueous composition formed from combining at least water and a first species that dissolves in water, wherein the aqueous composition generates carbon dioxide when said first species dissolves in water; and
placing the aqueous composition in close proximity to the perishable product, such that carbon dioxide generated from the aqueous composition raises the level of carbon dioxide in the environment surrounding the perishable.

2. A method as defined in claim 1, wherein the act of placing the aqueous composition in close proximity comprises the step of applying the aqueous composition directly to the perishable product.

3. A method as defined in claim 2, wherein the perishable product comprises food and the step of applying the aqueous composition directly comprises the step of spraying the aqueous composition onto the food.

4. A method as defined in claim 2, wherein the perishable product comprises food and the step of applying the aqueous composition directly comprises the step of immersing the food into the aqueous composition.

5. A method as defined in claim 1, wherein the first species comprises sodium bicarbonate.

6. A method as defined in claim 5, wherein the aqueous composition further comprises a second species that enhances the generation of carbon dioxide gas that is generated when the first species dissolves in water.

7. A method as defined in claim 6, wherein the second species comprises acetylsalicylic acid.

8. A method as defined in claim 7, wherein the act of placing the aqueous composition in close proximity comprises the step of applying the aqueous composition to an absorption device that is in close proximity with the perishable product, the absorption device comprising:
an absorbent material, wherein the absorbent material receives the aqueous composition.

9. A method as defined in claim 8, wherein the act of obtaining the aqueous composition comprises the step of forming the aqueous composition upon the application of water to the absorbent material of the absorption device, the water combining with sodium bicarbonate and acetylsalicylic acid deposited at the absorbent material.

10. A method as defined in claim 8, wherein the absorption device is placed in direct contact with the perishable product.

11. A method as defined in claim 8, wherein the absorption device further comprises a shell that encases the absorbent material, and wherein the shell has one or more holes that pass therethrough.

12. A method as defined in claim 11, wherein the act of obtaining the aqueous composition comprises the step of mixing at least water, sodium bicarbonate, and acetylsalicylic acid outside the shell of the absorption device.

13. A method as defined in claim 7, wherein the act of placing the aqueous composition in close proximity to the perishable product comprises the act of placing the aqueous composition in soil in close proximity to a living plant, such that carbon dioxide generated from the aqueous composition raises the level of carbon dioxide in the soil and environment surrounding the living plant.

14. A method for raising the level of carbon dioxide in an environment surrounding a perishable product so as to prolong the useable life of the perishable product, comprising the acts of:
obtaining an absorption device having:
a shell with a plurality of holes formed therethrough;
an absorbent material substantially enclosed by the shell; and
a composition deposited at the absorbent material, the composition comprising at least one species that when mixed with water generates carbon dioxide that is released into the environment surrounding the perishable product;
applying water to the absorbent material, such that the composition deposited at the absorbent material is mixed with the water, and such that the composition generates carbon dioxide; and
placing the absorption device in close proximity to the perishable product, such that the level of carbon dioxide in the environment surrounding the perishable product is increased.

15. A method as defined in claim 14, wherein the at least one species comprises sodium bicarbonate.

16. A method as defined in claim 14, wherein the composition further comprises acetylsalicylic acid.

17. A method as defined in claim 14, wherein the absorption device is a unitary structure.

18. A method as defined in claim 14, wherein the shell comprises a flexible material, and wherein the act of placing the absorption device in close proximity to the perishable product comprises placing the absorption device in a sealed bag comprising the perishable product.

19. A method as defined in claim 14, wherein the perishable product comprises food.

20. A method as defined in claim 14, wherein the perishable product comprises live plants, and wherein the act of placing the absorption device in close proximity to the perishable product comprises the act of placing the absorption device in a controlled environment in which the live plants grow.

21. A method as defined in claim 20, wherein the absorption device is placed in the soil next to the live plants.

22. An apparatus for raising the level of carbon dioxide in an environment surrounding a perishable product to extend the useable life of the perishable product, the apparatus comprising:
a top layer that is impermeable to the transfer of liquid;
a bottom layer that is permeable to the transfer of liquid;
an absorbent material substantially enclosed between the top layer and the bottom layer, the absorbent material being adapted to absorb liquid through the bottom layer; and
a composition deposited at the absorbent material, the composition being formed from combining at least water and a first species, wherein the first species generates carbon dioxide when mixed with water.

23. An apparatus as defined in claim 22, wherein the first species comprises sodium bicarbonate.

24. An apparatus as defined in claim 23, wherein the composition further comprises a second species that enhances the generation of carbon dioxide when the sodium bicarbonate is mixed with water.

25. An apparatus as defined in claim 24, wherein said second species comprises acetylsalicylic acid.

26. An apparatus as defined in claim 24, wherein the perishable product is placed on the top layer of the apparatus, and wherein the perishable product exudes exudates that comprise at least water, such that combining at least water and a first species occurs when the exudates of the perishable product are absorbed by the absorbent material.

27. An apparatus as defined in claim 26, wherein the apparatus is sealed in a package containing the perishable product.

28. An apparatus as defined in claim 27, wherein the perishable product comprises meat, such that exudates of the meat are absorbed by the absorbent material through the bottom layer of the apparatus, and such that water of the exudates mixes with the first species, thereby generating carbon dioxide.

28. A method for packaging meat in a sealed environment with an apparatus that raises the level of carbon dioxide in the sealed environment to extend the useable life of the meat, the method comprising the acts of:
obtaining the absorption device, the absorption device comprising:
a top layer that is impermeable to the transfer of liquid;
a bottom layer that is permeable to the transfer of liquid;
an absorbent material substantially enclosed between the top layer and the bottom layer, the absorbent material being adapted to absorb liquid through the bottom layer; and
a first species being deposited at the absorbent material, wherein the first species generates carbon dioxide when mixed with water;
placing the meat on the top layer of the absorption device; and
sealing the environment surrounding the meat and absorption device.

29. A method for packaging meat as defined in claim 28, wherein the meat exudes exudates that comprise at least water, and wherein the exudates are absorbed by the absorbent material through the bottom layer, such that the water of the exudates mixes with the first species, thereby generating carbon dioxide.

30. A method for packaging meat as defined in claim 29, wherein the absorption device further comprises a second species that is deposited at the absorbent material, wherein the second species mixes with the first species and the water of the exudates, thereby enhancing the generation of carbon dioxide by the first species.

31. A method for packaging meat as defined in claim 30, wherein the first species is sodium bicarbonate, and wherein the second species is acetylsalicylic acid.

32. A method for packaging meat as defined in claim 31, wherein the relative level of carbon dioxide in the sealed environment is raised by the generation of carbon dioxide, thereby extending the useable life of the meat.
